(19) United States
(12) Patent Application Publication
(10) Pub. No.: US 2018/0347609 A1
(43) Pub. Date: Dec. 6, 2018

(54) Modular Furniture with Sliding Bracket

(71) Applicant: R.T. London Company, Grand Rapids, MI (US)

(72) Inventors: Dale Haley, Olympia, WA (US); Alexander C. Conway, Olympia, WA (US)

(21) Appl. No.: 15/957,463

(22) Filed: Apr. 19, 2018

Related U.S. Application Data
(60) Provisional application No. 62/512,892, filed on May 31, 2017.

(51) Int. Cl. F16B 12/56; A47C 19/00; A47C 19/04; F16B 45/04

(52) U.S. Cl. CPC F16B 12/56; A47C 19/005; A47C 19/22; F16B 45/04; A47C 19/04

(57) ABSTRACT

Modular furniture can include a set of headboards including pin channels used for mounting furniture pieces and components. A bed frame, stabilizer rail, and other hanging items can be utilized in the modular furniture pieces. Any of which can include slidable mounting hardware to facilitate assembly of the modular furniture elements.

### CROSS-REFERENCE TO RELATED APPLICATION(S)

This application claims priority to U.S. Provisional Patent Application No. 62/512,892, filed May 31, 2017, which is incorporated herein by reference in its entirety.

### BACKGROUND

Case goods sold to institutions (such as schools and colleges, but not limited to) often include furniture consisting of headboards made from wood or metal. Usually the furniture is a bed and the term “headboards” typically includes both headboards and footboards, since they are often identical at least in dimension. Consequently, beds can optionally be stacked atop one another to form bunk beds and save space. Also, in colleges especially, it is common to mount the headboards on extenders so that the bed will be elevated, providing space beneath the bed for furniture pieces such as a variety of storage boxes, bed frames, work surfaces, shelves, wardrobe components and the like.

The construction of integrated headboards and furniture pieces is sometimes referred to as modular furniture, which can be arranged in a plurality of configurations. Typically, modular furniture is constructed by mounting beds and furniture pieces directly into the headboards using brackets, screws, bolts, and the like.

### BRIEF DESCRIPTION

An aspect of the present disclosure relates to a modular furniture assembly including a first headboard having at least one pin, a second headboard, a bed frame having a first end and a second end and the first end of the bed frame operably coupled to the first headboard and the second end of the bed frame operably coupled to the second headboard, and a stabilizer rail operably coupled between the first headboard and the second headboard including a body having a first distal end and a second distal end, and a hook assembly slidably mounted to the first distal end of the body, the hook assembly including at least one hook extending from a bracket body, the at least one hook configured to engaged with the at least one pin on the first headboard to couple the stabilizer rail to first headboard, wherein the hook assembly is slidable between a retracted position wherein at least a portion of the at least one hook overlaps the first distal end of the body and an extended position wherein the at least one hook extends past the first distal end of the body of the stabilizer rail.

Another aspect of the present disclosure relates to a stabilizer rail assembly for a modular furniture assembly having two headboards spaced apart from each other to define a first length, the stabilizer rail including a body having a first distal end and a second distal end spaced from the first distal end, a first hook assembly laterally slidably mounted to the first distal end, the first hook assembly including a first bracket body including at least one aperture extending therethrough, and a first set of hooks extending from a first exterior edge of the first bracket body and wherein the first hook assembly is laterally slideable between a retracted position wherein at least a portion of the first hook assembly overlaps the first distal end of the body and an extended position wherein a lesser portion of the first hook assembly overlaps the first distal end of the body.

### BRIEF DESCRIPTION OF THE DRAWINGS

In the drawings:

FIG. 1 is a perspective view of modular furniture according to an aspect of the present disclosure.

FIG. 2A is a perspective view of a stabilizer rail included in the modular furniture of FIG. 1 in an extended position.

FIG. 2B is a perspective view of a stabilizer rail included in the modular furniture of FIG. 1 in a retracted position.

FIG. 3 is a perspective view of the modular furniture of FIG. 1 in an unassembled state.

FIG. 4 is a perspective view of portions of the modular furniture of FIG. 1 partially assembled.

FIG. 5 is a perspective view of the partially assembled modular furniture of FIG. 4 in an upright position.

FIG. 6 is a perspective view of the partially assembled modular furniture of FIG. 5 with a stabilizer rail partially inserted.

FIG. 7 is a perspective view of the modular furniture of FIG. 5 with the stabilizer rail fully inserted and a hanging accessory exploded from the remainder of the furniture.

### DETAILED DESCRIPTION

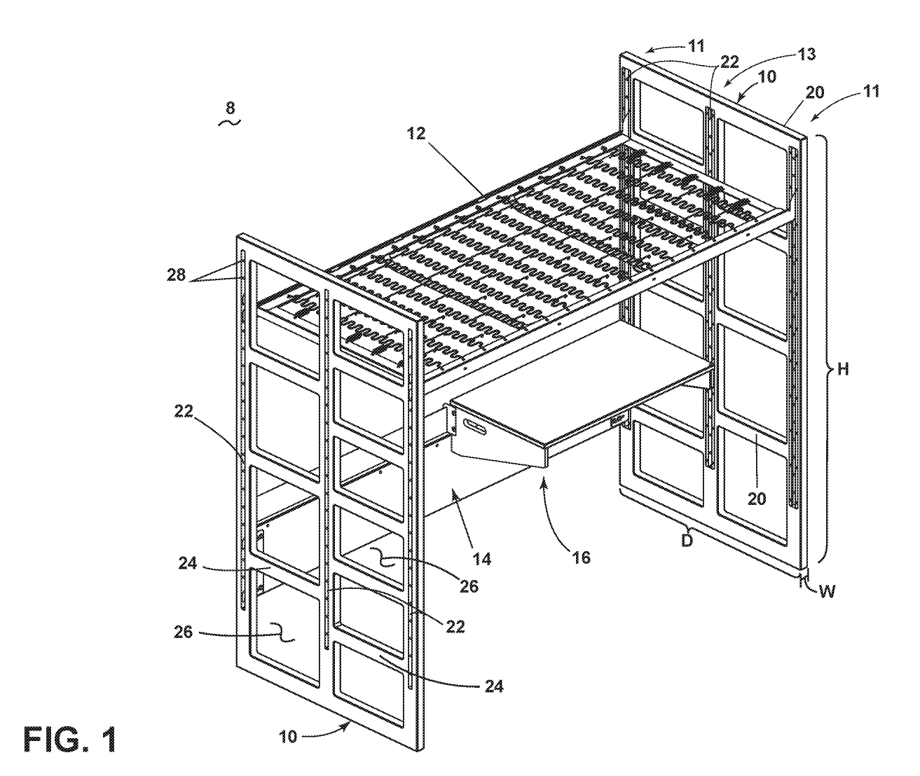

FIG. 1 shows modular furniture 8 according to an exemplary embodiment of the present disclosure. Headboards 10, bed frame 12, stabilizer bar 14, and hanging accessory 16 are illustrated as being included in the illustrated example. It will be understood that the modular furniture can have alternative or additional pieces including, among other things, headboards with alternative pin channels and additional hanging accessories including, but not limited to, a tray, a cubby, and a caddy.

In the illustrated example the headboards 10 are made up of a unitary or a single piece 20 of material having a set of pin channels 22. It will be understood that this is by way of non-limiting example and that the pin channels 22 can be included in separate pieces or operably coupled pieces. One example of a headboard with pin channels for use in modular furniture can based on the headboards or pin channels disclosed in Applicant's co-pending U.S. Publication No. 20170354264, entitled “Pin Channel Headboard,” filed on May 31, 2017, which is herein incorporated by reference in its entirety. Another example of pin channels that can be utilized in modular furniture can based on the pin channels disclosed in Applicant's U.S. Pat. No. 7,866,200, entitled “Bed Pin Channel,” issued Jan. 11, 2011, which is herein incorporated by reference in its entirety.

The configuration of the headboard 10, including, the height H, width W, depth D, crosspieces 24 and resulting open regions 26 is shown here by way of example only. It will be understood that the headboard 10 including the height H, width W, depth D, crosspieces 24 and resulting open regions 26 can be configured in any suitable manner. For example, the crosspieces 24 and resulting open regions 26 can be arranged in any desired configuration for aesthetic or structural preferences. By way of non-limiting examples, crosspieces 24 can be utilized as steps or the open regions 26 can allow access to either side of the headboard 10.

The headboards 10 can include spaced ends 11 where each spaced end 11 can include a pin channel 22. A middle portion 13 of the headboard 10 can also include a pin channel 22. While the illustrated set of pin channels 22 includes three pin channels 22, it will be understood that it is possible for the headboard 10 to have more or less than three pin channels 22. For example, additional pin channels 22 could be included depending on the configuration of the crosspieces 24 and resulting open regions 26. Regardless of how the pin channels 22 are formed they can include a plurality of pins 28 that can be accessible from one or both sides of the headboard 10. In the exemplary illustration, the plurality of pins 28 are accessible from either side of the headboard 10 although this need not be the case. The plurality of pins 28 are disposed horizontally along at least a portion of the length of the pin channels 22. The plurality of pins 28 can be integrally formed with the pin channels 22 or otherwise mounted thereto. The pin channels 22 can be formed from any suitable material including, but not limited to metal or composite.

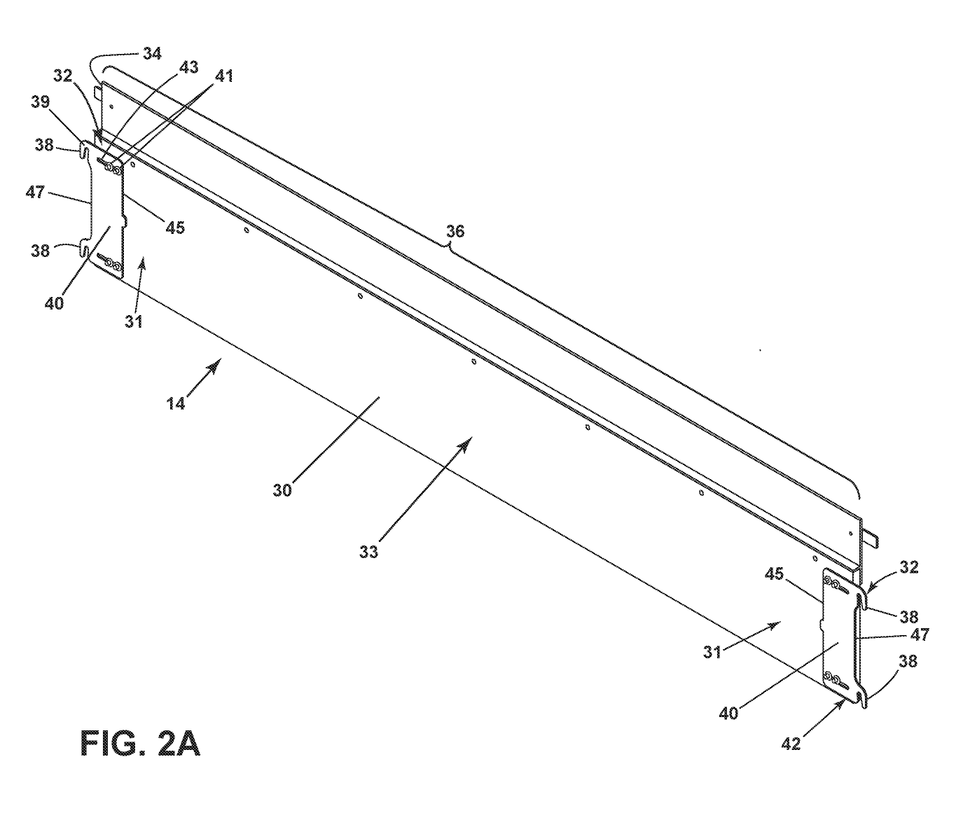

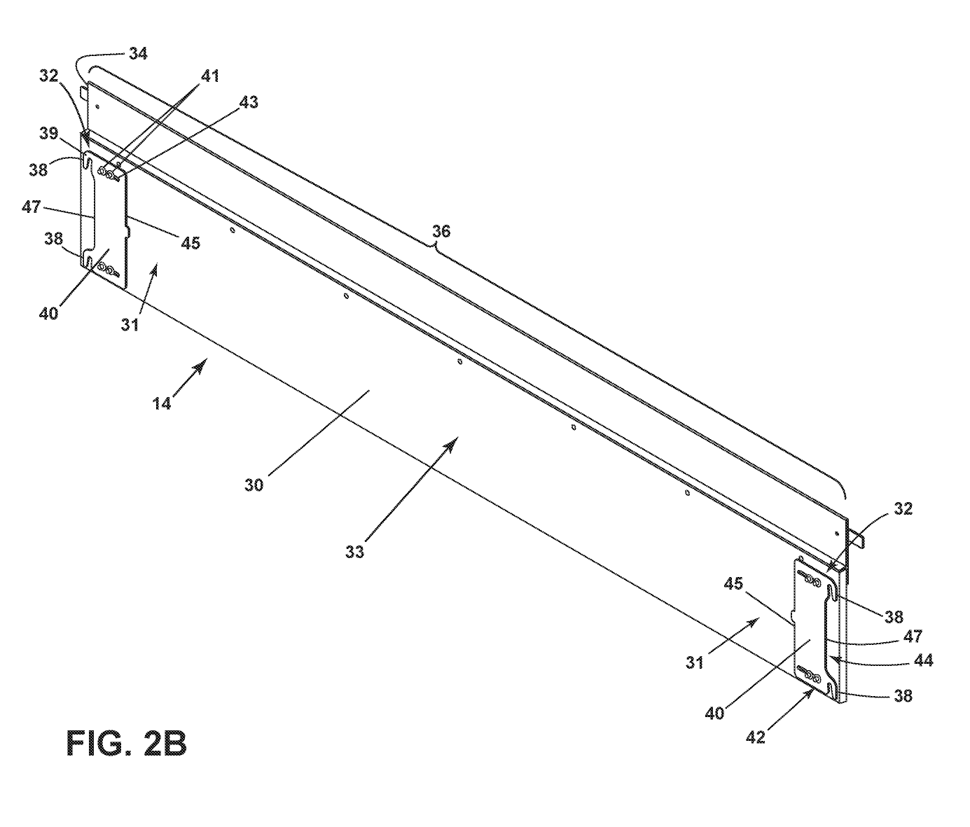

FIG. 2A is a perspective view of an exemplary stabilizer rail 14 that can be utilized in the modular furniture. The stabilizer rail 14 can be operably coupled between the headboards 10 to provide additional stability to the modular furniture 8. In the illustrated example, the stabilizer rail 14 includes a body 30, hook assemblies 32, and a rod 34. The body 30 can include two spaced, distal ends 31 and a middle portion 33 between the distal ends 31 together forming a length 36 of the body 30. In the illustrated example the body 30 is similar to a board. The hook assemblies 32 and the rod 34 can be coupled to the body 30.

Each hook assembly 32 can include a set of hooks 38 provided on and extending from a bracket body 40. The bracket body 40 can be flat such that it can overlap the stabilizer rail 14 body 30, and can include an interior edge 45 and an exterior edge 47. The interior edge 45 can be facing the middle portion 33 of the body 30 and the exterior edge can be facing the distal end 31 of the body 30. The bracket body 40 of the hook assembly 32 can be slidably coupled to the distal end 31 of the body 30. The bracket body 40 can be slidably mounted to the body 30 in any suitable manner. In the illustrated example, several fasteners 41 are mounted to the body 30 through an aperture 43 in the bracket body 40. The aperture 43 can include a length forming a slot and can be located anywhere on the bracket body 40. The hook assemblies 32 can be moved such that the fasteners 41 are slid from one end of the aperture 43 to the other end of the aperture 43. In this manner, the hook assemblies 32 are configured to laterally slide along the length between a retracted position 44, as seen in FIG. 2B, wherein portions of the hook assembly 32 overlap the body 30, and an extended position 42, as seen in FIG. 2A where a lesser portion of the hook assembly 32 overlaps the body 30. In the extended position 42, the hook assemblies 32 can engaged pins 28 of the pin channels 22 on each headboard 10 to couple the stabilizer rail 14 to the headboard 10.

While two hooks 38 are shown on the bracket body 40, it will be understood that “a set” can include any number of hooks, including only one hook 38. The hooks 38 can be integral with the bracket body 40 such that the hooks 38 are formed with the exterior edge 47. Alternatively, the hooks 38 can be separate from the bracket body 40. In either case, the set of hooks 38 extend further than the exterior edge 47. The hooks 38 can be disposed in vertical alignment along the exterior edge 47 and include curved portions 39 that are configured to operably couple with the vertically aligned pins 28 of the pin channels 22 such that the curved portions 39 fit over the pins 28. In the extended position 42, the set of hooks 38 extend past the distal end 31 of the body 30, while in the retracted position 44 at least a portion of the set of hooks 38 can overlap the distal end 31 of the body 30. The retracted position 44 can also include the set of hooks 38 completely overlapping the distal end 31 of the body 30 such that the set of hooks 38 do not extend past the distal end 31 and the entire hook assembly 32 overlaps the distal end 31 of the body 30. Additionally, the bracket body 40 can at least partially extend past the distal end 31 of the body 30 in the extended position.

While FIG. 2A illustrates two moveable hook assemblies 32, one hook assembly 32 on each distal end 31 of the stabilizer rail 14, it is possible for only a single distal end 31 to include a moveable hook assembly 32. Therefore, the stabilizer rail 14 can include a first distal end 31 having a moveable hook assembly 32, and a second distal end 31 without a hook assembly 32. It will be understood that the second distal end 31 can include any other suitable part for coupling the second distal end 31 to the headboard 10. Suitable parts can include, but are not limited to, a hook assembly that is not identical to the hook assembly 32, which can include a fixed hook assembly that is not slideable between a retracted 44 and extended position 42.

The rod 34 can be operably coupled, or mounted to any portion of the body 30 and has been illustrated as being mounted to an upper portion of the body 30. It will be understood that the rod need not be cylindrical and has been illustrated as being flat although this need not be the case. The rod 34 can allow for unlimited positioning options for the other pieces of the modular furniture to be hung on. Alternatively, the hanging pieces of the modular furniture 8 can be hung directly on the body. In an alternative example, openings can be provided within the body and can act as a catch upon which other pieces of the modular furniture 8 can be hung. Such openings could limit the positions the additional hanging pieces could be hung at.

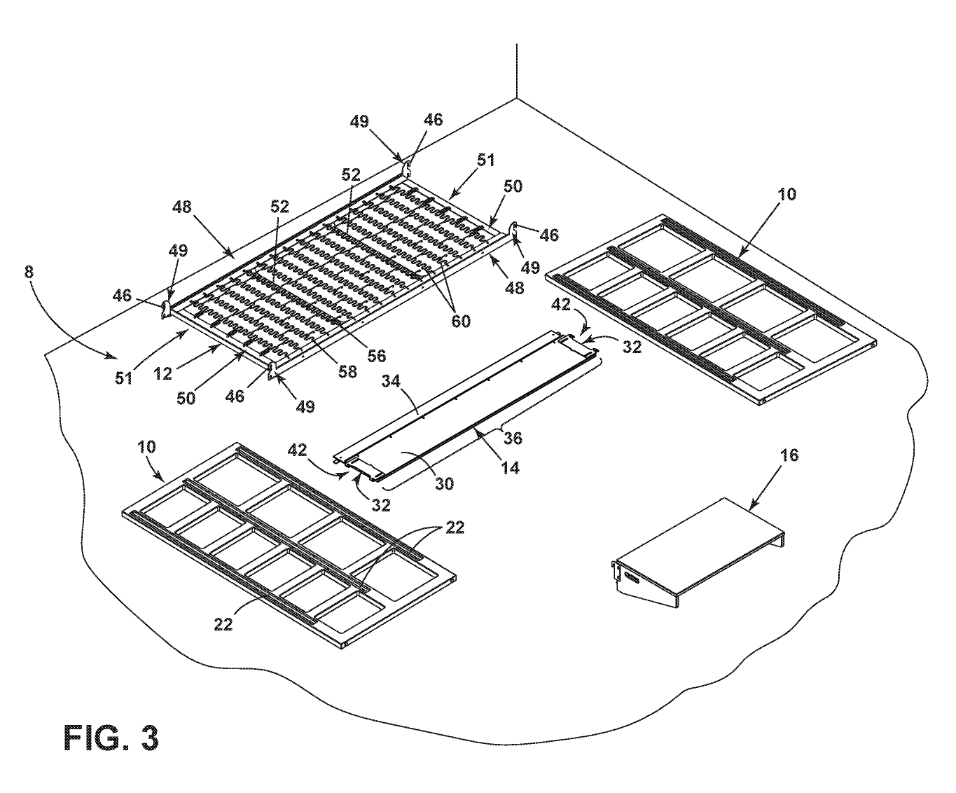

FIG. 3 illustrates the components of the modular furniture 8 unassembled. It will be understood that the bed frame 12 is merely an exemplary bed frame 12 having hooks 46, which can couple with the pin channel 22 on the headboard 10 to couple the bed frame 12 to the headboards 10. The bed frame 12 can include side rails 48 and a pair of cross supports 50 attached to each end of the side rails 48. The cross supports 50 can be thought of as ends 51 of the bed frame 12 such that the bed frame includes a first end 51 spaced from a second end 51. The side rails 48 can be roughly parallel to each other, while the cross supports 50 can be roughly parallel to each other, such that the side rails 48 and cross supports 50 form a rectilinear planform. Each side rail 48 can include two spaced ends 49 that can include the hooks 46. The cross supports 50 can be welded to the side rails 48, but can also be attached by using fasteners or by other methods. A pair of cross braces 52 serves to keep the side rails 48 roughly parallel. A number of apertures 58 can be created at various spots, which can allow a system of springs 60 to be attached through the apertures 58 to the bed frame 12. The system of springs 60 are coils of metal or any other material of any shape that can be drawn between two or more side rails that can support a mattress. Alternatively, a series of boards (not shown) can form a foundation in the bed frame 12 and can define a flat support surface that can consist of a single board or multiple boards made out of wood, metal, plastic, or other materials.

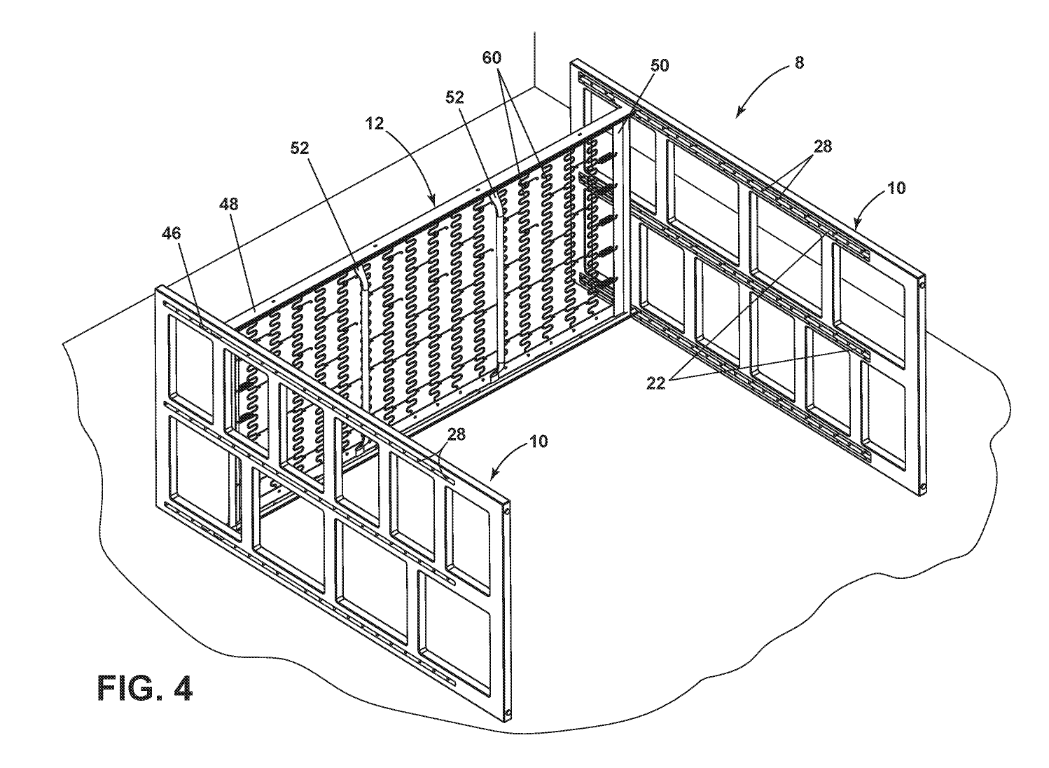

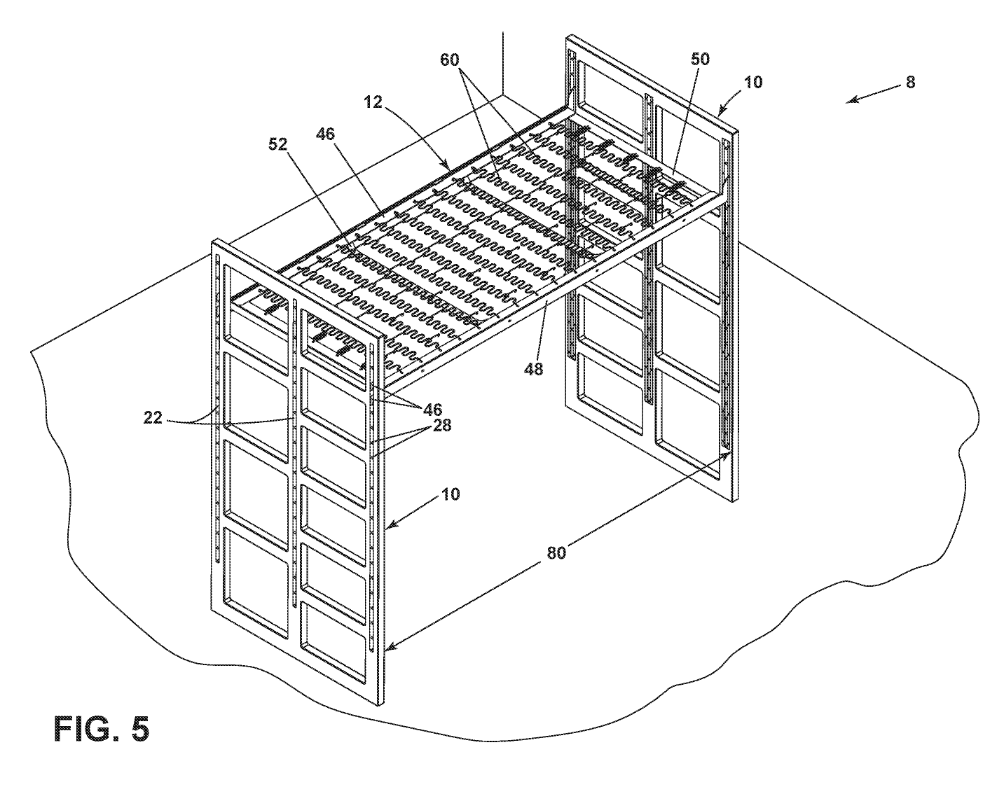

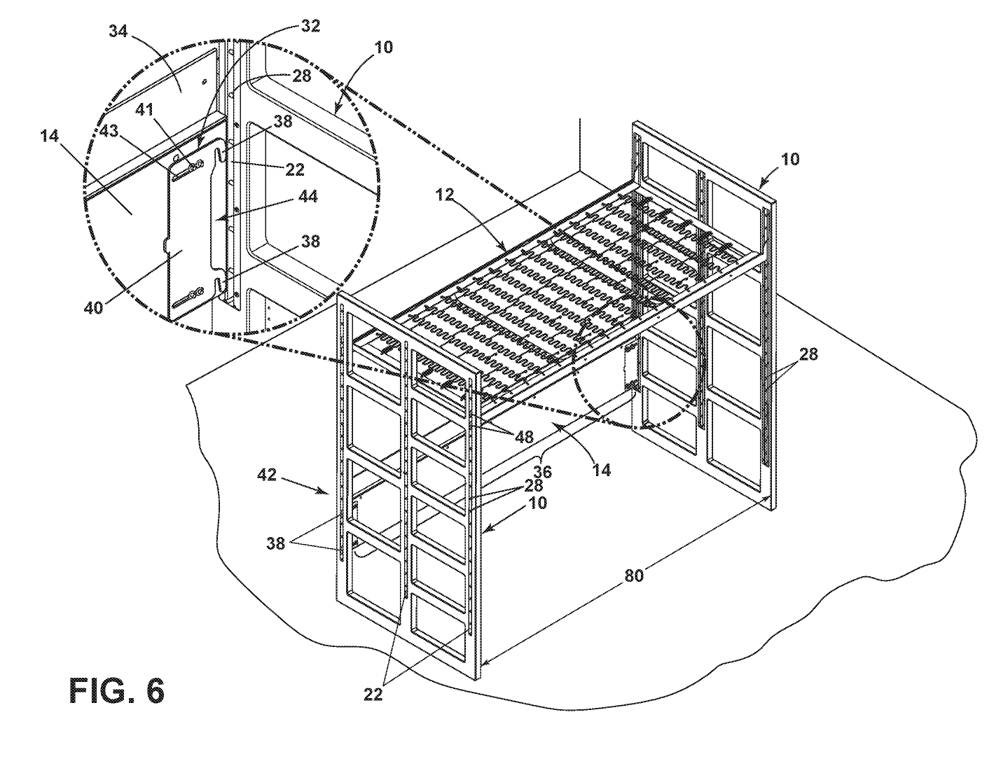

FIG. 4 is a perspective view of portions of the modular furniture of FIG. 1 partially assembled and laying on the floor. More specifically, the bed frame 12 has been hooked onto upper portions of the pin channels 22 of the headboards 10 such that the first end 51 and the second end 51 are operably coupled to the headboards 10. FIG. 5 shows the same assembly stood vertically. The headboards 10 can be used for constructing modular furniture with multiple furniture pieces in the same vertical space including, but not limited to, a variety of storage boxes, bed frames, work surfaces, shelves, desks, and wardrobe components. The bed frame 12 has been hooked onto the pin channels 22 with hooks 46 in the same horizontal position, and are therefore height-adjustable along the pin channels 22 and forming a loft bed. The loft bed as illustrated is coupled together only at the top and a space 80 defines the distance between the headboards 10 when coupled with the bed frame 12. It has been determined that the stabilizer rail 14 braces the modular furniture 8. The stabilizer rail 14 can be hooked at a first end to one headboards 10 as illustrated in FIG. 6. The stabilizer rail 14 can be hooked onto the headboard 10 via the hook assembly 32 on any of the pins 28 within the pin channels 22 such that the stabilizer rail 14 is height adjustable along the pin channels 22.

The hook assembly 32 on the second end can be moved to the retracted position 44 so that the stabilizer rail 14 can fit within the space 80 between the headboards 10 easily. The length 36 can be sized to fit between the headboards 10 when the bed frame 12 is attached to the headboards 10. Thus, the length 36 can be substantially equal to or just less than the length of the bed frame 12. In the extended position 42, the set of hooks 38 can extend past the ends of the body 30, while in the retracted position 44, the set of hooks 38 may not extend past the ends of the body 30.

The length 36 can be sized in order for the stabilizer rail 14 to fit within the space 80 only when a single one of the hook assemblies 32 is in the retracted position 44 such that only one of the hook assemblies 32 needs to be in the retracted position 42 and the other hook assembly 32 can be in the extended position 44. For example, the first distal end 31 can have a corresponding hook assembly 32 in the extended position 42, which can be hooked onto the pin channel 22 in the headboard 10, while the corresponding hook assembly 32 on the second distal end 31 can be in the retracted position 42 in order to fit between the space 80. Then, the hook assembly 32 on the second distal end 31 can be moved to the extended position 42 and can hook onto the pin channel 22 on the other headboard 10 in the same horizontal position as the pin channel 22 coupled with the first distal end 31. The fasteners 41 can be tightened to secure the hook assemblies 32 in the desired position, such as in the extended position 42.

Additionally, the length 36 can be sized such that the stabilizer rail 14 can fit within the space 80 between the headboards 10 mounted to the bedframe 12 only when both hook assemblies 32 are in the retracted position 44. In this case, the hook assemblies 32 on the first distal end 31 and the second distal end 31 are in the retracted position 44 before the stabilizer rail 14 is placed within the space 80. Once the stabilizer rail 14 is in position within the space 80, each hook assembly 32 can be moved to the extended position 42 to hook onto each headboard 10. Then, the fasteners 41 can be tightened to secure the hook assemblies 32 in position. It will be understood that in the illustrated configuration that the stabilizer rail 14 is meant to be positioned generally horizontal across the space defined by the headboards 10.

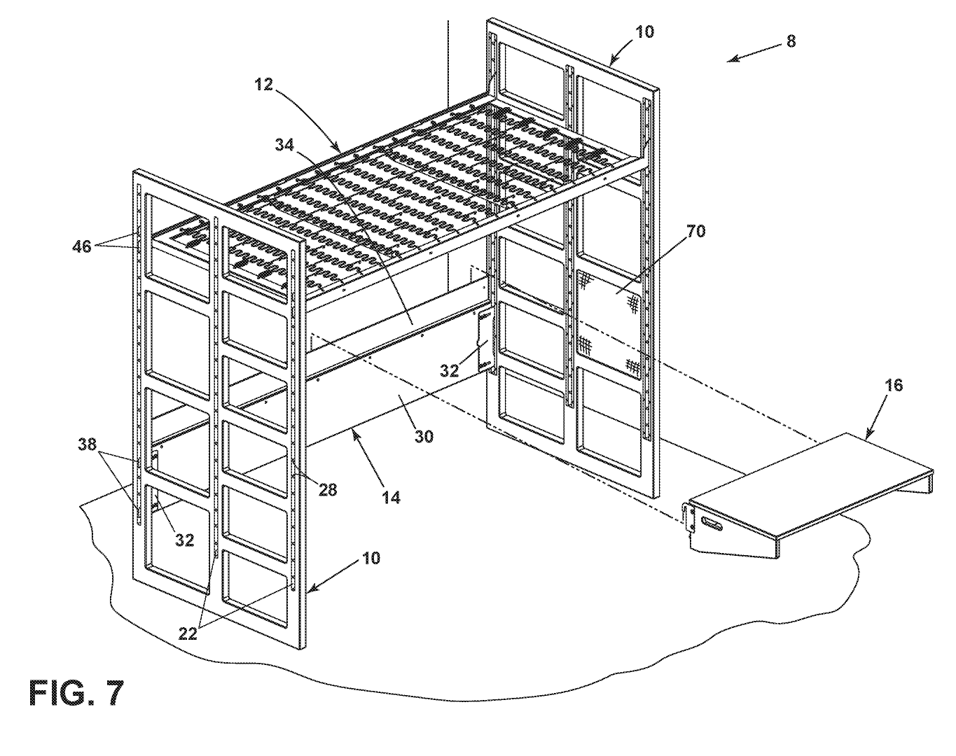

FIG. 7 is a perspective view of the modular furniture of FIG. 5 with the stabilizer rail fully inserted onto both headboards 10. Further still, an insert panel 70 has been illustrated in one of the open regions 20. The insert panel 70 can be, by way of non-limiting example, press fit into the opening. The insert panel 70 can be cushioned, tackable or writable. While FIG. 7 shows the desk 16 exploded from the rod 34 it will be understood that to construct the modular furniture as illustrated in FIG. 1, the desk 16 merely needs to be hung onto the rod 34. It will be noted that in the illustrated example, the pin channels 22 are accessible via two opposite sides of the headboard 10 and furniture pieces can be hung from either side of the headboard 10. Since the pin channels 22 comprise a plurality of pins 28 disposed horizontally, the furniture pieces are height adjustable along the pin channels 22. Moreover, the furniture pieces can be arranged in different horizontal positions (i.e. the right side or left side of the headboard). The accessibility of opposite sides of the headboard 10, the height adjustability of the furniture pieces, and the horizontal positioning of the furniture pieces allows for numerous configurations for the modular furniture without the use of tools.

It will be understood that the modular furniture 8 as illustrated is for exemplary purposes. Other examples of configurations can include that the desk can be removed, additional furniture pieces, and also furniture pieces not shown such as work surfaces, shelves, wardrobe components, a lounge, an ottoman, a ladder, a table, or any other suitable furniture pieces.

To the extent not already described, the different features and structures of the various embodiments can be used in combination with each other as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A modular furniture assembly comprising:
a first headboard having at least one pin;
a second headboard;
a bed frame having a first end and a second end and the first end of the bed frame operably coupled to the first headboard and the second end of the bed frame operably coupled to the second headboard; and
a stabilizer rail operably coupled between the first headboard and the second headboard, comprising:
a body having a first distal end and a second distal end; and
a hook assembly slidably mounted to the first distal end of the body, the hook assembly including at least one hook extending from a bracket body, the at least one hook configured to engaged with the at least one pin on the first headboard to couple the stabilizer rail to first headboard;
wherein the hook assembly is slidable between a retracted position wherein at least a portion of the at least one hook overlaps the first distal end of the body and an extended position wherein the at least one hook extends past the first distal end of the body.

2. The modular furniture assembly of claim 1 wherein the at least one hook of the hook assembly completely overlaps the body of the stabilizer rail in the retracted position such that the at least one hook does not extend past the stabilizer rail body.

3. The modular furniture assembly of claim 1 wherein the bracket body further comprises an aperture having an aperture length and the hook assembly is configured to laterally slide along the aperture length between the retracted position and the extended position.

4. The modular furniture assembly of claim 3 wherein a fastener is mounted to the body and extends through the aperture to fix the bracket body in the retracted position or the extended position.

5. The modular furniture assembly of claim 1 wherein the stabilizer rail further comprises a rod operably coupled to the body.

6. The modular furniture assembly of claim 1 wherein the first headboard further comprises a pin channel and wherein the at least one pin comprises a plurality of pins in the pin channel.

7. The modular furniture assembly of claim 6 wherein the second headboard further comprises a second pin channel including a plurality of pins and the stabilizer rail is height adjustable along the pin channels.

8. The modular furniture assembly of claim 7 wherein the stabilizer rail comprises a second hook assembly slidably mounted to the second distal end of the body, the second hook assembly including at least one hook extending from a second bracket body, the at least one hook configured to engaged with at least one of the plurality of pins of the second pin channel to couple the stabilizer rail to second headboard.

9. The modular furniture assembly of claim 8 wherein a length of the body of the stabilizer rail body is sized to fit between the first headboard and the second headboard when the first headboard and the second headboard are mounted to the bed frame and the first hook assembly and the second hook assembly are both in the retracted position.

10. The modular furniture assembly of claim 8 wherein a length of the body of the stabilizer rail body is sized to fit between the first headboard and the second headboard when the first headboard and the second headboard are mounted to the bedframe and one of the first hook assembly and the second hook assembly is in the retracted position and the other is in the extended position.

11. The modular furniture assembly of claim 7, wherein the bed frame further comprises spaced ends, each end having a hook configured to couple with a pin channel on one of the headboards.

12. The modular furniture assembly of claim 1, wherein the first headboard and the second headboard each comprise two spaced ends, each spaced end having a pin channel, and wherein the bed frame comprises first and second side rails, the first and second side rails each having two spaced ends, each end having a hook, where the hooks on the ends of the first and second side rails couple with one of the pin channels on the first headboard and one of the pin channels on the second headboard to form a rectilinear planform.

13. The modular furniture assembly of claim 1 wherein the at least one hook on the bracket body includes a set of hooks.

14. The modular furniture assembly of claim 13 wherein the set of hooks are disposed in vertical alignment.

15. A stabilizer rail assembly for a modular furniture assembly having two headboards spaced apart from each other to define a first length, the stabilizer rail comprising:
a body having a first distal end and a second distal end spaced from the first distal end;
a first hook assembly laterally slidably mounted to the first distal end, the first hook assembly, comprising:
a first bracket body including at least one aperture extending therethrough; and
a first set of hooks extending from a first exterior edge of the first bracket body and wherein the first hook assembly is laterally slideable between a retracted position wherein at least a portion of the first hook assembly overlaps the first distal end of the body and an extended position wherein a lesser portion of the first hook assembly overlaps the first distal end of the body.

16. The stabilizer rail assembly of claim 15, further comprising a second hook assembly laterally slidably mounted to the second distal end, the second hook assembly, comprising:
a second bracket body including at least one aperture extending there through; and
a second set of hooks extending from a second exterior edge of the bracket body and wherein the second hook assembly is laterally slideable between a retracted position wherein at least a portion of the second hook assembly overlaps the second distal end of the body and an extended position wherein a lesser portion of the second hook assembly overlaps the second distal end of the body.

17. The stabilizer rail assembly of claim 16 wherein the body, first hook assembly, and second hook assembly are sized such that only one of the first hook assembly or the second hook assembly needs to be in the retracted position to fit the stabilizer rail assembly within the first length.

18. The stabilizer rail assembly of claim 15 wherein the at least one aperture includes a length configured to allow the first hook assembly to laterally slide between a retracted position wherein the entire first hook assembly overlaps the first distal end and an extended position wherein at least a portion of the first set of hooks extends past the first distal end.

19. The stabilizer rail assembly of claim 15, wherein the first hook assembly completely overlaps the first distal end of the body in the retracted position such that the first hook assembly does not extend past first distal end of the body.

20. The stabilizer rail assembly of claim 15, wherein the first set of hooks extend past the first distal end of the body in the extended position.
